(19) United States
(12) Patent Application Publication
(10) Pub. No.: US 2008/0159277 A1
(43) Pub. Date: Jul. 3, 2008

(54) ETHERNET OVER FIBRE CHANNEL

(75) Inventors: Suresh Vobbilisetty, San Jose, CA (US); John Michael Terry, San Jose, CA (US)

Correspondence Address: HENSLEY KIM & HOLZER, LLC, 1660 LINCOLN STREET, SUITE 3000, DENVER, CO, 80264, US

(73) Assignee: BROCADE COMMUNICATIONS SYSTEMS, INC., San Jose, CA (US)

(21) Appl. No.: 11/958,348

(22) Filed: Dec. 17, 2007

Related U.S. Application Data
(60) Provisional application No. 60/870,166, filed on Dec. 15, 2006.

(51) Int. Cl. H04L 12/50

(52) U.S. Cl. 370/357

(57) ABSTRACT

A network architecture provides Ethernet services over a Fibre Channel (FC) storage area network infrastructure. The fabric provides transparent bridging services to Ethernet end stations connected at the edge of the FC fabric via multi-protocol switches that support Ethernet over Fibre Channel (EoFC) technology. An Ethernet frame is received from a first Ethernet edge network by an ingress Ethernet port of a first virtual bridge and is encapsulated in a FC frame shell to form an EoFC frame. The EoFC frame is then transmitted out an egress FC port of the first virtual bridge and routed through the FC fabric using an FC routing protocol. When the encapsulated frame reaches an ingress FC port of a second virtual bridge, the EoFC frame is de-encapsulated to yield the original Ethernet frame, which is transmitted out an egress Ethernet port of the second virtual bridge into a second Ethernet edge network.

### CROSS-REFERENCE TO RELATED APPLICATIONS

The present application claims benefit of U.S. Provisional Patent Application No. 60/870,166, filed Dec. 15, 2006 and entitled “Ethernet over Fibre Channel”, which is specifically incorporated by reference for all that it discloses and teaches.

The subject matter of the present application is also related to concurrently filed U.S. patent application Ser. No. ______ [Docket No. 112-0205US/233-628-USP], filed Dec. 17, 2007 and entitled “Ethernet Forwarding in High Performance Networks”, and U.S. Provisional Patent Application No. 60/870,170, filed on Dec. 15, 2006 and entitled “Ethernet Forwarding in High-Performance Fabrics,” both of which are also specifically incorporated by reference for all that they disclose and teach.

### BACKGROUND

A storage area network (SAN) may be implemented as a high-speed, special purpose network that interconnects different kinds of data storage devices with associated data servers on behalf of a large network of users. Typically, a storage area network includes high performance switches as part of the overall network of computing resources for an enterprise. The storage area network is usually clustered in close geographical proximity to other computing resources, such as mainframe computers, but may also extend to remote locations for backup and archival storage using wide area network carrier technologies. Fibre Channel (FC) networking is typically used in SANs although other communications technologies may also be employed, including Ethernet and IP-based storage networking standards (e.g., iSCSI, FCIP (Fibre Channel over IP), etc.).

In a typical SAN, one or more Fibre Channel switches are used to communicatively connect one or more server devices with one or more data storage devices. Such switches generally support a high performance switching fabric and provide a number of communication ports for connecting to other switches, servers, storage devices, or other SAN devices. Other high performance fabrics may employ different fabric technologies, such as Infiniband.

Other networking technologies, such as Ethernet, may also be employed in communicating between computing and networking devices. However, these networking technologies do not work seamlessly with high performance networks, such as a Fibre Channel fabric. Traditionally, SCSI (Small Computer System Interface) technology has provided the only widely used protocol over FC. Existing FC standards have not adequately specified how Ethernet packets may be transported over FC and how Ethernet addresses are resolved to FC addresses. For example, Ethernet frames cannot be routed through a Fibre Channel fabric in such a way that Ethernet services are easily provided over the fabric.

### SUMMARY

Implementations described and claimed herein address the foregoing problems by providing a network architecture and associated methods for enabling Ethernet services over a Fibre Channel (FC) storage area network (SAN) infrastructure. The FC fabric provides transparent bridging services to standards-compliant Ethernet end stations connected at the edge of the FC SAN infrastructure via multi-protocol switches that support Ethernet over Fibre Channel (EoFC) technology. Example Ethernet services may include, for example, source address learning and uni-cast forwarding. In one implementation, a virtual EoFC bridge provides an interface between Ethernet and FC networks so as to support transparent bridging services across a FC core network spanning multiple Ethernet edge networks.

In one implementation, an Ethernet frame is received from a first Ethernet edge network by an ingress Ethernet port of a first virtual bridge and is encapsulated in a Fibre Channel frame shell to form an EoFC frame. The EoFC frame is then transmitted out an egress FC port of the first virtual bridge and routed through the FC core network using a standard Fibre Channel routing protocol (e.g., FSPF). When the encapsulated frame reaches an ingress FC port of a second virtual bridge, the EoFC frame is de-encapsulated to yield the original Ethernet frame, which is transmitted out an egress Ethernet port of the second virtual bridge into a second Ethernet edge network.

The virtual bridge also handles the addressing of the encapsulated EoFC frame for transmission through the FC core network. For example, the received Ethernet frame includes a destination MAC address and a source MAC address in its Ethernet header. The virtual frame determines an appropriate destination identifier (D_ID) and source identifier (S_ID) for the EoFC frame to allow Domain_ID/Port_ID based routing through the FC core network.

Other implementations are also described and recited herein.

### BRIEF DESCRIPTIONS OF THE DRAWINGS

FIG. 1 illustrates an example network having an Ethernet edge and a Fibre Channel network core.

FIG. 2 illustrates an example multi-protocol virtual bridge supporting Ethernet over Fibre Channel.

FIG. 3 illustrates an example encapsulated EoFC frame format.

FIG. 4 illustrates an architecture of an example multi-protocol virtual bridge supporting Ethernet over Fibre Channel.

FIG. 5 illustrates example operations for creating a virtual bridge supporting Ethernet over Fibre Channel.

FIG. 6 illustrates example operations for learning destination IDs and forwarding frames via a virtual bridge supporting Ethernet over Fibre Channel.

### DETAILED DESCRIPTIONS

In one scenario, an organization having a Fibre Channel core network configured as a SAN may wish to use the FC core network to communicate Ethernet frames. For example, a computer cluster is a group of loosely coupled computers that work together closely in such a way that they resemble a single computer. The components of a cluster are commonly, but not always, connected to each other through a fast local area network (LAN). The components may also be connected to large amounts of storage via a SAN. Rather than duplicating interconnectivity among cluster computers and data storage (e.g., with both an Ethernet network and a Fibre Channel network), an Ethernet-over-Fibre Channel (EoFC) approach can exploit the overlapping connectivity that would be furnished by the two network topologies and instead provide network communications via a single high performance Fibre Channel network while providing Ethernet services to Ethernet nodes connected to the Fibre Channel network.

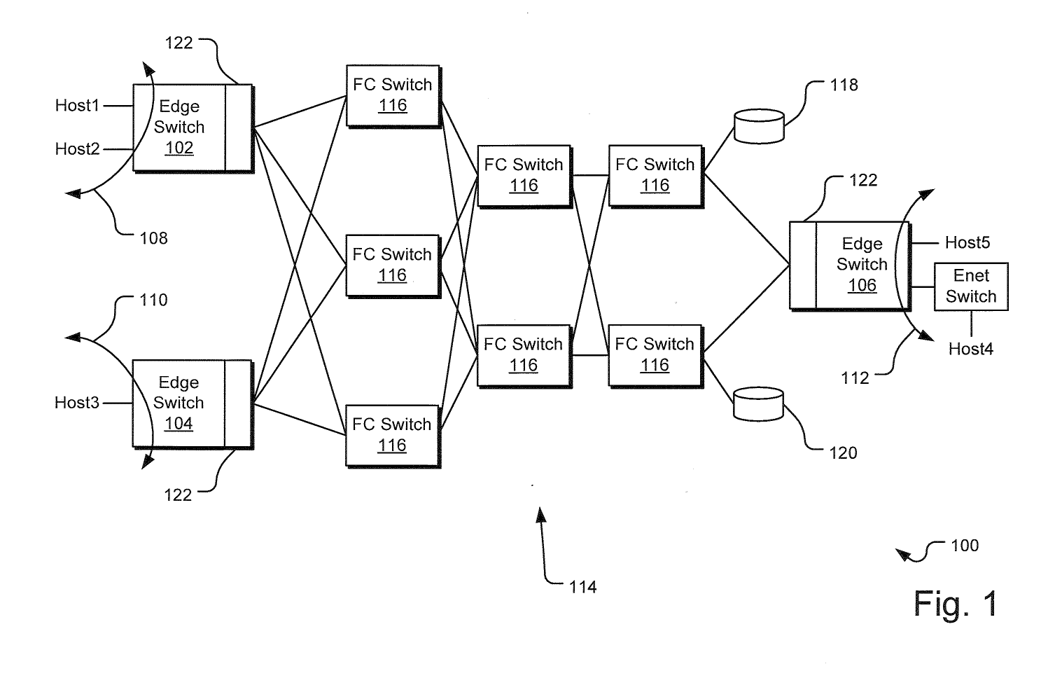

FIG. 1 illustrates an example network 100 having Ethernet edge networks 108, 110, and 112 and a Fibre Channel network core 114. The Ethernet edge is represented by edge switches 102, 104, and 106, which embody EoFC virtual bridges between the Ethernet edge networks 108, 110, and 112 and the Fibre Channel network core 114. Each edge switch 102, 104, and 106 includes a Fibre Channel interface 122 that provides physical connectivity to the FC core network 114. Additional Ethernet-connected devices, such as Host1, Host2, Host3, Host4, and Enet Switch, are nodes of the Ethernet edge networks 108, 110, and 112 connected to the edge switches 102, 104, and 106. The hosts and other Ethernet nodes may be termed “Ethernet end stations” to denote their roles as sources and destinations of Ethernet communications through the FC core network 114.

The Fibre Channel network core 114 includes FC switches 116, which interconnect the edge switches 102, 104, and 106 and storage devices 118 and 120. It should be understood that host computers (not shown) may also be interconnected through the Fibre Channel network core 114. As used herein, the term “Fibre Channel” refers to the Fibre Channel family of standards (developed by the American National Standards Institute (ANSI)) and other related and draft standards. In general, Fibre Channel defines a transmission medium based on a high speed communications interface for the transfer of large amounts of data via connections between varieties of hardware devices.

As described above, each edge switch embodies an EoFC virtual bridge. In one implementation, a virtual bridge includes virtual ports capable of taking on personalities of Fibre Channel ports or Ethernet ports. The virtual bridge connects to the FC core network via a physical FC port, configured as an E_PORT, and connects to the Ethernet edge network via a physical Ethernet port set in either user-port mode or switch-port mode. Each virtual Ethernet port corresponds to a physical FC port. Each virtual FC port corresponds to a physical Ethernet port and can be used as an N_PORT connecting the Ethernet edge to the FC core 114 via the virtual bridge. All virtual FC ports of a virtual bridge are assigned N_PORT_IDs. Each virtual bridge has a FC Domain_ID allocated to it, just as a physical FC switch would have.

The virtual bridge generally evokes thoughts of elements from a standard IEEE 802.1Q bridge emulated over a standard FC-FS-transport. The architecture combines functionality of an Ethernet bridge with a Fibre Channel switch. Accordingly, the virtual bridge is capable of transparently switching Ethernet frames from the ingress Ethernet ports from one of the Ethernet edge networks to another egress Ethernet port on a different Ethernet edge network through the FC core network.

In one implementation, an Ethernet frame is received from a first Ethernet edge network by an ingress Ethernet port of a first virtual bridge and is encapsulated in a Fibre Channel frame shell to form an EoFC frame. The EoFC frame is then transmitted out an egress FC port of the first virtual bridge and routed through the FC core using a standard Fibre Channel routing protocol (e.g., FSPF). When the encapsulated frame reaches an ingress FC port of a second virtual bridge, the EoFC frame is de-encapsulated to yield the original Ethernet frame, which is transmitted out an egress Ethernet port of the second virtual bridge into a second Ethernet edge network.

The virtual bridge also handles the addressing of the encapsulated EoFC frame for transmission through the FC core network 114. For example, the received Ethernet frame includes a destination MAC address and a source MAC address in its Ethernet header. The virtual frame determines an appropriate destination identifier (D_ID) and source identifier (S_ID) for the EoFC frame to allow Domain_ID/Port_ID based routing through the FC core network.

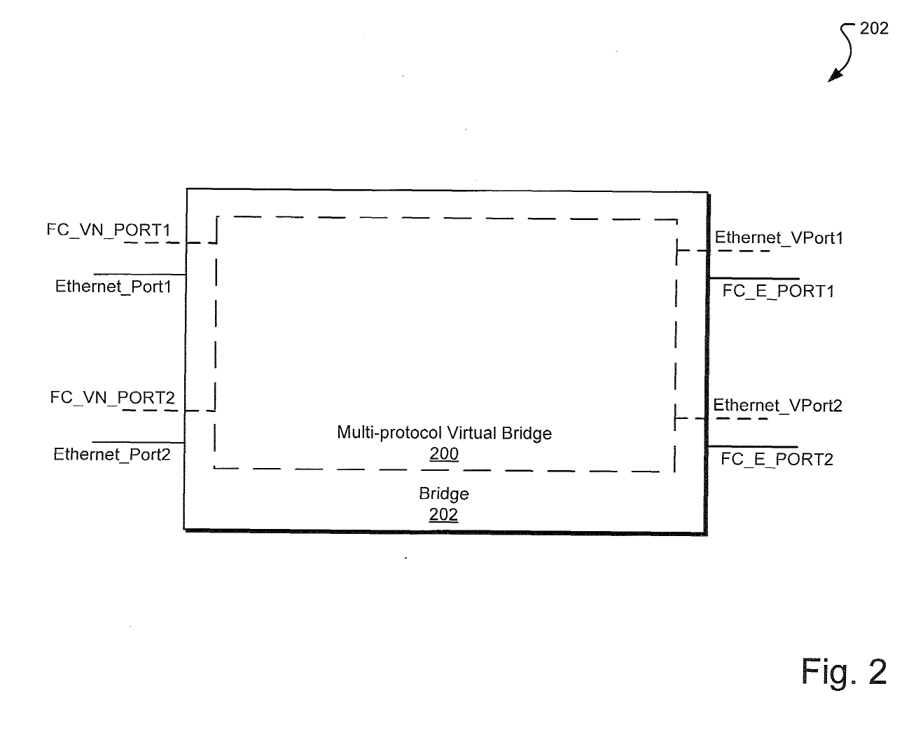

FIG. 2 illustrates an example multi-protocol virtual bridge 200 supporting Ethernet over Fibre Channel. The multi-protocol virtual bridge 200 is instantiated in a physical bridge 202, which includes both physical FC ports (e.g., FC_L_PORT1 and FC_L_PORT2), connecting the virtual bridge 200 to a FC core network, and physical Ethernet ports (Ethernet_Port1 and Ethernet_Port2), connecting the virtual bridge 200 to an Ethernet edge network. The multi-protocol virtual bridge 200 participates in the FC fabric protocol via the physical FC ports, FC_L_PORT₁ and FC_L_PORT2. The physical FC ports can be configured as E_PORTs or Ex_PORTs on a single link or as a trunk port.

The virtual bridge 200 configures virtual ports for each physical port. In FIG. 2, the physical Ethernet ports (Ethernet_Port1 and Ethernet_Port2) are individually paired with virtual FC N_PORTs (FC_VN_PORT1 and FC_VN_PORT1). Likewise, the physical FC ports (FC_E_PORT₁ and FC_L_PORT2) are individually paired with virtual Ethernet ports (Ethernet_VPort1 and Ethernet_VPort2).

As previously described, an Ethernet frame that is received from a first Ethernet edge network by an Ethernet port (e.g., Ethernet_Port1) of an ingress virtual bridge 200 is encapsulated in a Fibre Channel frame shell to form an EoFC frame. The EoFC frame is configured with appropriate FC source and destination identifiers (e.g., S_ID and D_ID) and is transmitted out a physical FC port (e.g., FC_E_PORT1) of the ingress virtual bridge 200 and through the FC core network. When the Ethernet frame is received by the virtual bridge 200 on one of its physical Ethernet ports, the Ethernet frame includes a media access controller (MAC) address indicating an Ethernet destination (i.e., a destination address or DA) and a MAC address indicating an Ethernet source (i.e., a source address or SA). Accordingly, to transfer the received Ethernet frame through the FC core network via the ingress virtual bridge 200 to another Ethernet edge network, the ingress virtual bridge 200 determines destination Port_ID (i.e., D_ID) and the source Port_ID (i.e., S_ID) for the frame so that it may be routed within the FC core to its Ethernet edge destination.

In one implementation, to determine the S_ID, the ingress virtual bridge 200 generates N_PORT_IDs for each virtual N_PORT in the ingress virtual bridge 200 at initialization time. A Domain_ID is assigned to the virtual switch, and the ingress virtual bridge 200 allocates an N_PORT_ID having the following form, where the Port_ID the middle field represents a Ethernet Port Identifier (ENet_Port_ID) of the physical Ethernet port (e.g., a port number of the Ethernet port on the virtual bridge):

TABLE 1
Example N_PORT_ID format

| 8 bits | 10 bits | 6 bits |
|---|---|---|
| [23:17] | [16-6] | [5:0] |
| Domain_ID | ENet_Port_ID | Reserved |

The N_PORT_ID format applies to both destination identifiers (D_IDs) and source identifiers (S_IDs). In one implementation, the ingress virtual bridge 200 uses mapping information to determine the S_ID associated with a specific physical ingress Ethernet port that receives an Ethernet frame for transmission through the FC core network. The (physical) port-to-S_ID mapping is determined at initialization time and recorded in a local port-to-S_ID datastore (e.g., table) in the ingress virtual bridge 200. The mapping information is used during operation to determine the source N_PORT_ID that is to be inserted into the S_ID of the FC frame shell that will be used to encapsulate the received Ethernet frame for its transmission through the FC core network. The virtual bridge may also report the mapping out to a local FC name server. In this manner, other virtual bridges may learn the mapping attributable to the source end station's MAC address.

In one implementation, to determine the D_ID, ingress the virtual bridge 200 consults a MAC-to-D_ID datastore (e.g., a table) to determine the D_ID associate with the destination MAC address received in destination address field of the Ethernet frame. The determined D_ID is inserted into the D_ID field of the FC frame shell that will be used to encapsulate the received Ethernet frame for its routing through the FC core network (e.g., using a Domain_ID/Port_ID based routing protocol such as FSPF. In some circumstances, the MAC-to-D_ID table may not have a record for the destination MAC address of a received Ethernet frame. In such conditions, a multicast D_ID may be used to route the encapsulated EoFC frame to a select group of switches in the fabric (e.g., all virtual bridges on the Ethernet edge, all switches in the fabric, etc.).

The encapsulated EoFC frame is then transmitted into the FC core network via the physical FC port (e.g., FC_L_PORT1) for routing through the FC core network to an egress virtual bridge at another Ethernet edge network. Note: If the D_ID indicates that the destination domain for the egress virtual bridge is the same as the domain of the ingress virtual bridge, no encapsulation or transmission through the FC core network is needed. Instead, the virtual bridge can merely transmit the received Ethernet frame through one of its physical Ethernet ports, in a manner similar to that of a standard Ethernet switch.

The egress virtual bridge, which has approximately the same structure and functionality as ingress virtual bridge 200, receives the encapsulated EoFC frame at a physical FC port (e.g., identified in this description as FC_L_PORT2, although it should be understood that this description is referring to two different virtual bridges, an ingress virtual bridge 200 and an egress virtual bridge).

The egress virtual bridge receives the encapsulated EoFC frame, which contains a D_ID and S_ID provided by the ingress virtual bridge 200. The egress virtual bridge de-encapsulates the received frame and forwards the resulting Ethernet frame through a physical Ethernet port based on the ENet_Port_ID in the D_ID of the FC frame shell of the received EoFC frame.

If the D_ID field of the encapsulated EoFC frame shell is a multicast ID, then the egress virtual bridge forwards the de-encapsulated Ethernet frame to a select group of physical Ethernet ports in the egress virtual bridge that belong to the VLAN indicated by the VSAN tag in the FC frame shell of the received EoFC frame. It should be understood that the select group may be filtered to ensure that no loops are encountered in the Ethernet edge network.

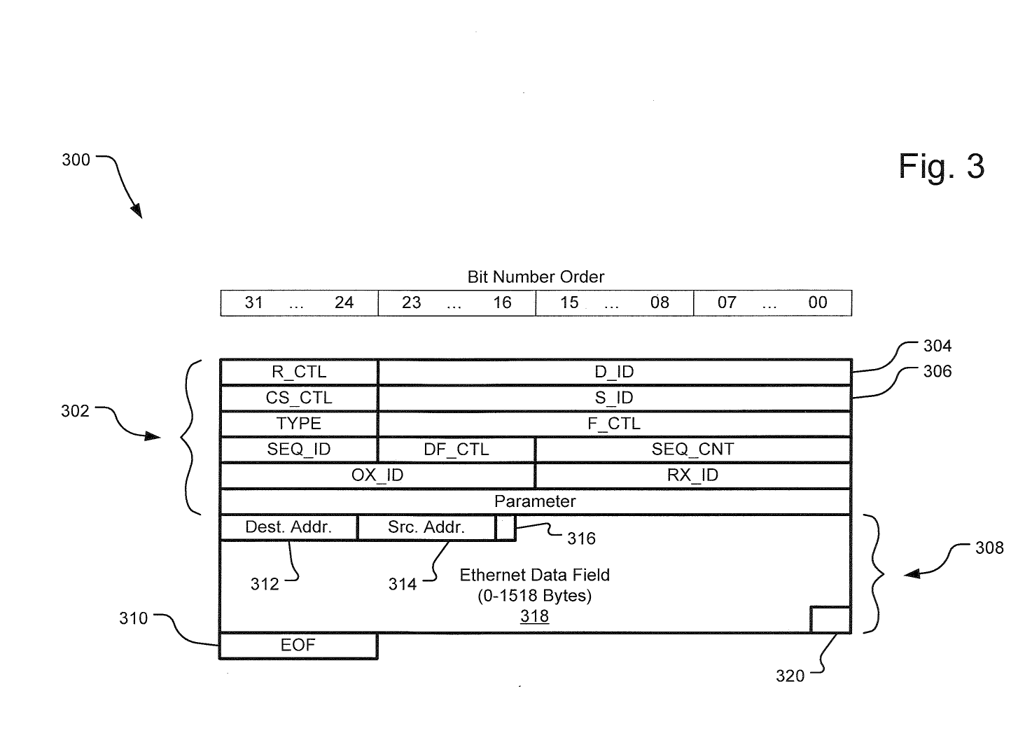

FIG. 3 illustrates an example encapsulated EoFC frame format 300. The ingress Ethernet port of a virtual bridge receives the Ethernet frame 308 and encapsulates it in Fibre Channel frame shell to form the encapsulated EoFC frame 300. Words 302 represent fields of a standard FC header of a FC frame. The Fibre Channel frame shell includes a destination ID (D_ID) field 304 containing the Domain_ID and ENet_Port_ID of the virtual N_PORT of the egress virtual bridge connected to the destination Ethernet edge network. The Fibre Channel frame shell also includes a source ID (S_ID) field 306 containing the Domain_ID of the ingress virtual bridge and the ENet_Port_ID of the intended physical Ethernet port of the ingress edge switch. An End-Of-Frame (EOF) field 310 resides at the end of the EoFC frame 300. Other standard FC frame fields are also shown in FIG. 3 and may be used in accordance with known standards or with some variations to facilitate EoFC operation.

The Ethernet frame 308 is encapsulated in the payload field of the FC frame. A destination address field 312 is specified to store a 6-byte Ethernet MAC address of the intended recipient device. A MAC address is a form of layer-2 (“L2”) address in communication architectures. A source address field 314 is specified to store a 6-byte Ethernet MAC address of the transmitting device. A 2-byte type field 316 is specified to store either the number of MAC-client data bytes that are contained in the Ethernet data field 318 of the frame, or the frame type ID if the frame is assembled using an optional format. If the type field value is less than or equal to 1500, the number of bytes in the Ethernet data field 318 is equal to the type field value. If the type field value is greater than 1536, the frame is of an optional type, and the type field value identifies the particular type of frame being transmitted or received. The Ethernet frame 308 also includes a frame checksum field 320.

Upon receipt, the egress virtual bridge de-encapsulates the original Ethernet frame 308 from the EoFC frame 300 and forwards it into the Ethernet edge network through the port designated by the destination ENet_Port_ID in the D_ID 304 of the FC frame shell. The original Ethernet frame 308 includes the original source and destination Ethernet MAC addresses used for routing the frame 308 through the Ethernet edge networks.

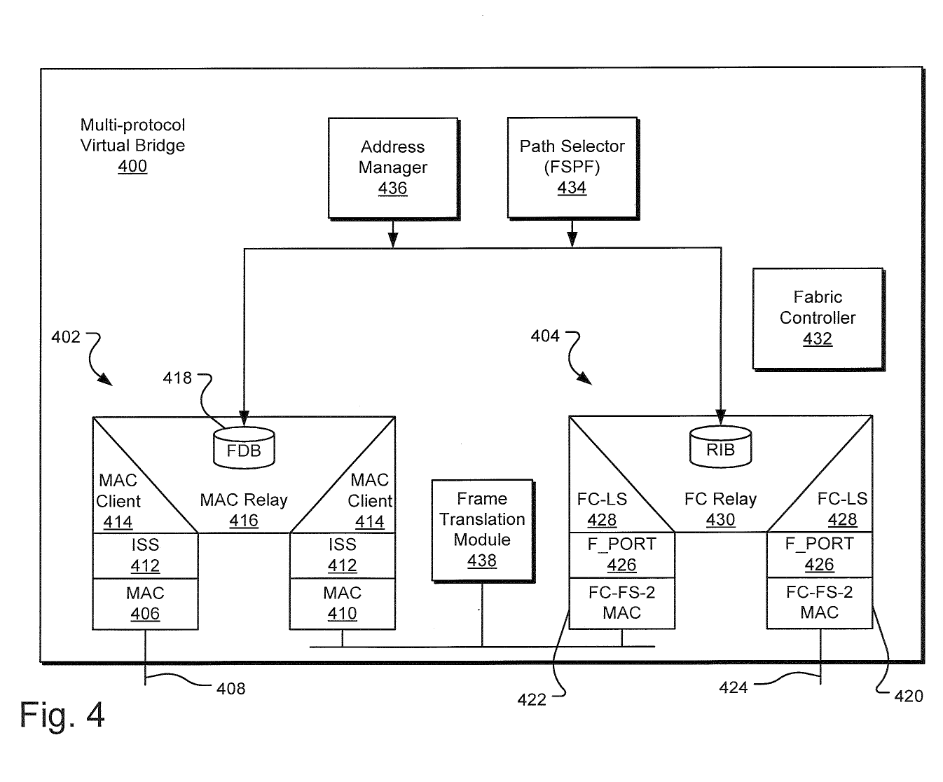

FIG. 4 illustrates an architecture of an example multi-protocol virtual bridge 400 supporting Ethernet over Fibre Channel. Each virtual bridge becomes part of the FC fabric by participating in the FC Fabric Protocol. Once the virtual bridge has been assigned a FC Domain_ID, a control plane process can discover all of the other virtual switches connected to the FC core. This discovery results in a vector of Domain_IDs of each virtual bridge connected to the FC core. The vector may be stored in a table and used by FSPF (Fabric Shortest Path First), a high performance routing protocol, to prune the multicast tree that is used to forward any multicast Ethernet frames, encapsulated in FC frame shells, through the FC core network.

The virtual bridge 400 resembles an Ethernet switch cascaded with a Fibre Channel switch. However, the two component switches are integrated to act as a single virtual domain. As illustrated, the virtual bridge 400 includes an Ethernet switch component 402 and a FC switch component 404. Furthermore, one-to-one correspondences may be established between physical Ethernet ports and virtual FC ports of the Ethernet switch component 402, as well as between physical FC ports and virtual Ethernet ports of the FC switch component 404.

The Ethernet switch component 402 includes an MAC module 406 connecting the Ethernet switch component 402 to a physical Ethernet port 408 of the virtual bridge 400 and another MAC module 410 connecting the Ethernet switch component 402 to the FC switch component 404.

Both sides of the Ethernet switch component 402 include ISS (Internal Sublayer Service) modules 412 and MAC clients 414. The Ethernet switch component 402 also includes a MAC relay 416, which has access to a forwarding database (FDB) 418. The FDB 418 represents a memory cache in the Ethernet switch component 402 and contains a table of destination Domain_IDs and associated ENet_Port_IDs. The FDB 418 also includes the port-to-S_ID mappings used for address translation by the MAC relay 416. The FDB 418 may be populated in at least three ways: by learning, by manual operator entry and by predefined data. The Ethernet switch component 402 looks up the Domain_ID and the ENet_Port_ID of a received frame's source, based on the physical ingress Ethernet port of the virtual bridge 400 that received that Ethernet frame.

The FC switch component 404 includes a FC-FS-2 MAC module 406 connecting the FC switch component 404 to a physical FC port 424 of the virtual bridge 400 and another FC-FS-2 MAC module 420 connecting the FC switch component 404 to the Ethernet switch component 402. The physical FC port 424 connects the virtual bridge 400 to the FC core network.

Both sides of the FC switch component 404 include F_PORT modules 426 and Fibre Channel Link Service (FC-LS) modules 428. The FC switch component 404 also includes a FC relay 430, which has access to a routing information base (RIB) 432. The RIB 432 represents a memory cache in the FC switch component 404 and contains a table of destination Domain_IDs and associated Port_IDs. The RIB 432 also includes the MAC-to-D_ID mappings used for address translation by the FC relay 430. The RIB 432 may be populated in at least three ways: by learning, by manual operator entry and by predefined data. The FC switch component 404 looks up the Domain_ID and the ENet_Port_ID to form the D_ID associated with the received frame's destination, based on the destination MAC address of the end station indicated in the Ethernet header to which the EoFC frame will be routed.

The virtual bridge 400 includes an address manager 436 that allocates Domain_IDs and Port_IDs within the switch and coordinates those IDs within the fabric. A standard Fibre Channel fabric controller 432, which assigns N_PORT_IDs in the virtual bridge 400. A path selector 434 updates the FDB 418 and RIB 432 with routing information pertaining to the fabric. It should also be understood that the FDB 418 and RIB 432 may be integrated into a single datastore.

A frame translation module 438 encapsulates an Ethernet frame received from the Ethernet edge network in the FC frame shell for transmission through the fabric. When an encapsulated FC frame is received from the fabric, the frame translation 438 de-encapsulates the frame to expose the Ethernet frame inside for transmission to the Ethernet edge network.

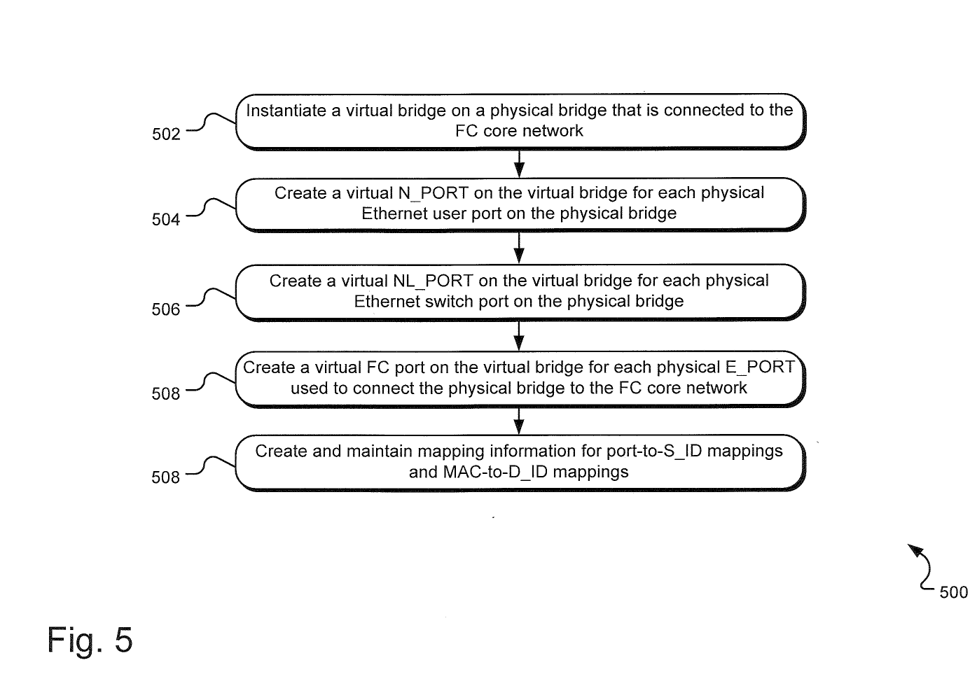

FIG. 5 illustrates example operations 500 for creating a virtual bridge supporting Ethernet over Fibre Channel. An instantiation module 502 instantiates a virtual bridge instance on a physical bridge device that is connected at the network edge between an Ethernet edge network and a FC core network. The virtual bridge instance is also given a Domain_ID by the FC fabric.

A creation operation 504 creates a virtual N_PORT on the virtual bridge instance for each physical Ethernet user port on the physical bridge. The physical Ethernet user ports are given an ENet_Port_ID at configuration time, and the virtual N_PORT is assigned a virtual Port_ID based on the virtual bridge's Domain_ID and the physical Ethernet port's ENet_Port_ID. It should be understood that other virtual port identifier formats also may be employed.

A creation operation 506 creates a virtual NL_PORT (i.e., a variety of a standard N_PORT) on the virtual bridge instance for each physical Ethernet switch port on the physical bridge. The physical Ethernet user ports are given an ENet_Port_ID at configuration time, and the virtual NL_PORT is assigned a virtual Port_ID based on the virtual bridge's Domain_ID and the physical Ethernet port's ENet_Port_ID. It should be understood that other virtual port identifier formats also may be employed.

A third creation operation 508 creates a virtual FC port on the virtual bridge for each physical E_PORT used to connect the physical bridge to the FC core network. An addressing operation 510 creates and maintains mapping information (e.g., in one or more local mapping table, in one or more name servers, etc.) for port-to-S_ID mappings and MAC-to-D_ID mappings. Using such mapping information, the virtual bridge can determine the S_IDs and D_IDs needed for the FC frame shells that encapsulate received Ethernet frames for transmission through the FC core network.

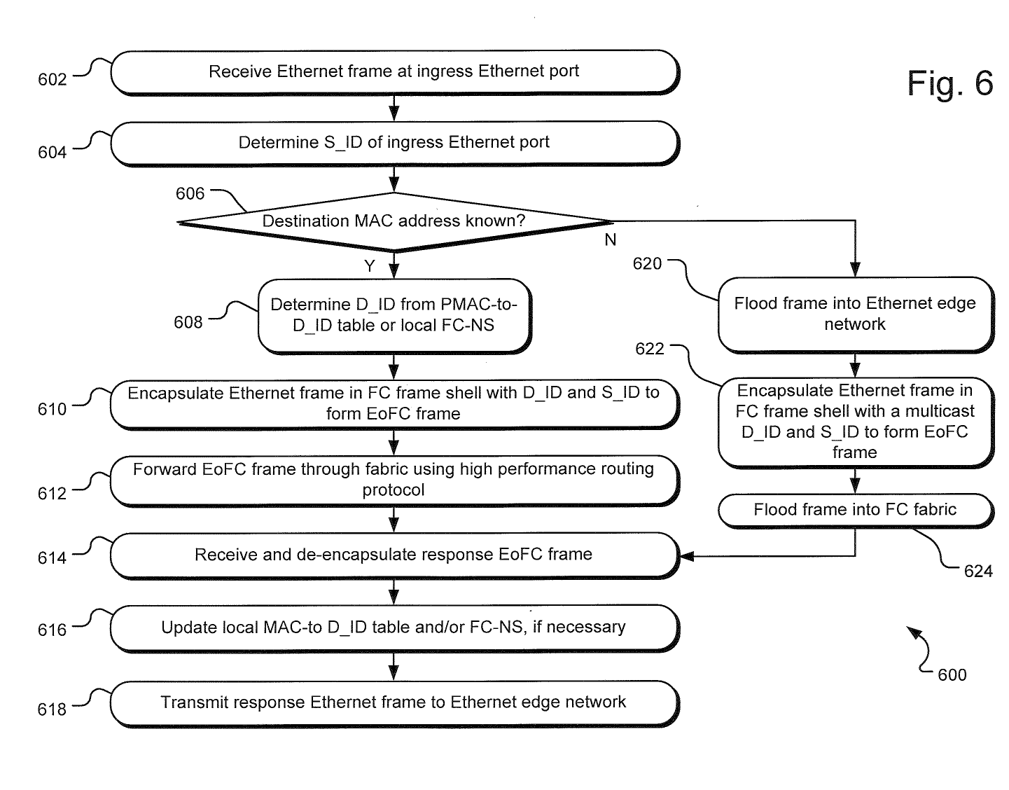

FIG. 6 illustrates example operations 600 for learning destination IDs and forwarding frames via a virtual bridge supporting Ethernet over Fibre Channel technology. A reception operation 602 receives an Ethernet frame at an ingress Ethernet port of the virtual bridge. An addressing operation 604 determines the S_ID to be included in the FC frame shell that will encapsulate the received Ethernet frame to form the EoFC frame that will be transmitted through the FC core network. In one implementation, the virtual bridge may determine the S_ID based on the physical ingress Ethernet port through which the Ethernet frame was received via a look up in a local port-to-S_ID table. The virtual bridge may also update its MAC-to-D_ID mapping, based on the source MAC address in the received Ethernet frame and the physical ingress Ethernet port number, by updating a local MAC-to-D_ID table and reporting the mapping out to a local FC name server. In this manner, other virtual bridges may learn the mapping attributable to the source end station's MAC address.

A decision operation 606 determines whether the destination MAC address of the received Ethernet frame is known in a mapping information source (e.g., recorded in a local MAC-to-D_ID table or accessible through a local FC name server). If so, a determining operation 608 extracts the appropriate D_ID from the mapping information source. An encapsulation operation 610 encapsulates the received Ethernet frame in a FC frame shell with the determined D_ID and S_ID to form an EoFC frame. A forwarding operation 612 transmits the EoFC frame through the FC fabric using a high performance routing protocol (e.g., FSPF).

The EoFC frame is received across the fabric by an egress virtual bridge, which de-encapsulates the Ethernet frame and transmits it through one of its physical Ethernet ports, identified in the D_ID of the EoFC frame, to the end station in its Ethernet edge network indicated by the destination MAC address in the Ethernet frame. At some time after said transmission to the destination end station, it is assumed the end station will transmit a response Ethernet frame back through its virtual bridge for encapsulation and routing across the fabric to the original virtual bridge.

A reception operation 614 at the original ingress virtual bridge receives the response EoFC frame, which it de-encapsulates. If a mapping between the S_ID of the response EoFC frame and the source MAC address of the response Ethernet frame is not recorded in the virtual bridge's mapping information (e.g., a local mapping table or a local FC name server), then an update operation 616 updates the mapping information based on the response EoFC frame received in the reception operation 614. A transmission operation 618 transmits the response Ethernet frame through one of its physical Ethernet ports, identified in the D_ID of the response EoFC frame, to the end station in its Ethernet edge network indicated by the destination MAC address in the response Ethernet frame.

If the decision operation 606 determines that the destination MAC address of the received Ethernet frame is not known in a mapping information source (e.g., recorded in a local MAC-to-D_ID table or accessible through a local FC name server), an Ethernet flooding operation 620 floods the received Ethernet frame into the Ethernet edge network from which it was received. An encapsulation operation 622 also encapsulates the received Ethernet frame in an FC frame shell to form an EoFC frame. The S_ID of the ingress Ethernet port and a D_ID indicating routing to a select group of switches in the fabric (e.g., all virtual bridges on the Ethernet edge, all switches in the fabric, etc.) are configured as the addressing of the EoFC frame. An FC flooding operation 624 transmits the EoFC frame into the fabric using the multicast D_ID.

It is assumed that the flooded EoFC frame is received across the fabric by an egress virtual bridge that recognizes the destination MAC address of the encapsulated Ethernet frame. This egress virtual frame, which de-encapsulates the Ethernet frame and transmits it through a select group of its physical Ethernet ports, based on VSAN tags and/or loop-avoidance, to the end station in its Ethernet edge network indicated by the destination MAC address in the Ethernet frame. At some time after said transmission to the destination end station, it is also assumed the end station will transmit a response Ethernet frame back through its virtual bridge for encapsulation and routing across the fabric to the original virtual bridge. Processing then continues with the reception operation 614, the updating of mapping information in updating operation 616, and transmission of the response Ethernet frame into the destination Ethernet edge network to the destination end station.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A method of forwarding an Ethernet frame from a first Ethernet edge network through a fabric that supports multi-path routing to a second Ethernet edge network, wherein the Ethernet frame has addressing that includes a physical L2 destination address of a destination end station on the second Ethernet edge network, the method comprising:
receiving the Ethernet frame on a physical Ethernet port of a bridge;
determining a source identifier for the Ethernet frame based on the physical Ethernet port on which the Ethernet frame was received;
determining a destination identifier for the Ethernet frame based on the physical L2 destination address of the Ethernet frame;
encapsulating the Ethernet frame in a Fibre Channel (FC) frame shell having addressing including the destination identifier and the source identifier to form an Ethernet over Fibre Channel (EoFC) frame;
forwarding the EoFC frame through the fabric toward another bridge at the second Ethernet edge network, based on the destination identifier.

2. The method of claim 1 wherein the destination identifier includes a domain identifier of the other bridge.

3. The method of claim 1 wherein the destination identifier includes a port identifier of the second bridge, the port identifier specifying a port number of a physical Ethernet port on the other bridge to which the destination end station is coupled.

4. The method of claim 1 wherein the source identifier includes a domain identifier of the bridge and a port identifier of the bridge, the port identifier specifying a port number of the physical Ethernet port on which the Ethernet frame was received.

5. The method of claim 1 wherein the operation of determining a destination identifier comprises:
looking up the destination identifier in a local mapping datastore, based the physical L2 destination address of the destination end station, the local mapping datastore indicating a mapping relationship between the physical L2 destination address of the destination end station and the destination identifier.

6. The method of claim 1 wherein the operation of determining a destination identifier comprises:
querying a FC name server for the destination identifier based the physical L2 destination address of the destination end station, the FC name server indicating a mapping relationship between the physical L2 destination address of the destination end station and the destination identifier.

7. A bridge device for forwarding an Ethernet frame from a first Ethernet edge network through a fabric that supports multi-path routing to a second Ethernet edge network, wherein the Ethernet frame has addressing that includes a physical L2 destination address of a destination end station on a second Ethernet edge network, the bridge device comprising:
an Ethernet media access controller (MAC) module coupled to the first Ethernet edge network and configured to receive the Ethernet frame on a physical Ethernet port of the bridge device;
a Fibre Channel (FC) MAC module coupled to the fabric and configured to transmit an Ethernet over Fibre Channel (EoFC) frame through the fabric toward another bridge at the second Ethernet edge network;
one or more relay modules coupled to the Ethernet MAC module and FC MAC module, the relay modules being configured to determine a source identifier for the Ethernet frame based on the physical Ethernet port on which the Ethernet frame was received and determining a destination identifier for the Ethernet frame based on the physical L2 destination address;
a frame translation module coupled to receive the Ethernet frame through one of the relay modules and being configured to encapsulate the Ethernet frame in a FC frame shell for addressing including the destination identifier and the source identifier to form the Ethernet over Fibre Channel frame.

8. The bridge device of claim 7 wherein the destination identifier includes a domain identifier of the other bridge.

9. The bridge device of claim 7 wherein the destination identifier includes a port identifier of the other bridge, the port identifier specifying a port number of a physical Ethernet port on the other bridge to which the destination end station is coupled.

10. The bridge device of claim 7 wherein the one or more relay modules look up the destination identifier in a local mapping datastore, based the physical L2 destination address of the destination end station, the local mapping datastore indicating a mapping relationship between the physical L2 destination address of the destination end station and the destination identifier.

11. The bridge device of claim 7 wherein the one or more relay modules query a FC name server for the destination identifier based the physical L2 destination address of the destination end station, the FC name server indicating a mapping relationship between the physical L2 destination address of the destination end station and the destination identifier.

12. A method of determining a destination identifier in a fabric for an Ethernet frame received from a first Ethernet edge network, wherein the Ethernet frame has addressing that includes a physical L2 destination address of a destination end station on a second Ethernet edge network, the method comprising:
receiving the Ethernet frame on a physical Ethernet port of a bridge;
encapsulating the Ethernet frame in a Fibre Channel (FC) frame shell having addressing including a destination identifier destined for select switches coupled to the fabric to form an Ethernet over Fibre Channel (EoFC) frame;
forwarding the EoFC frame through the fabric toward another bridge at the second Ethernet edge network;
receiving a response EoFC frame from the destination end station through the other bridge, the response EoFC frame including a response Ethernet frame generated by the destination end station, the response EoFC frame being formed of the response Ethernet frame encapsulated in an FC frame shell, the FC frame shell having addressing including a source identifier of the other bridge that generated the response EoFC frame and the response Ethernet frame including a physical L2 address of the destination end station that generated the response Ethernet frame;
updating mapping information accessible by the bridge defining a mapping relationship between the physical L2 address of the destination end station that generated the response Ethernet frame and the source identifier of the other bridge.

13. The method of claim 12 further comprising:
transmitting the Ethernet frame into the first Ethernet edge network, if a destination identifier associated with the destination end station is not known by the bridge.

14. The method of claim 12 wherein the mapping information resides in a mapping datastore maintained by the bridge.

15. The method of claim 12 wherein the mapping information resides in a FC name server accessible by the bridge.

16. The method of claim 12 wherein the select switches coupled to the fabric are represented by multiple virtual bridges on the Ethernet edge.

17. A bridge device for determining a destination identifier in a fabric for an Ethernet frame received from a first Ethernet edge network, wherein the Ethernet frame has addressing that includes a physical L2 destination address of a destination end station on a second Ethernet edge network, the bridge device comprising:
an Ethernet media access controller (MAC) module coupled to the first Ethernet edge network and configured to receive the Ethernet frame on a physical Ethernet port of the bridge device;
a Fibre Channel (FC) MAC module coupled to the fabric and configured to transmit an Ethernet over Fibre Channel (EoFC) frame through the fabric toward another bridge at the second Ethernet edge network;
one or more relay modules module coupled to the Ethernet MAC module and FC MAC module, the relay modules being configured to encapsulate the Ethernet frame in a FC frame shell having addressing including a destination identifier destined for select switches coupled to the fabric to form the EoFC frame,
wherein the FC MAC module is further configured to receive a response EoFC frame having a response Ethernet frame encapsulated in an FC frame shell, the FC frame shell having addressing including a source identifier of another bridge device that generated the response EoFC frame and the response Ethernet frame having a physical L2 address of the other bridge device;
a path selector module coupled to a mapping datastore and configured to update the mapping datastore to define a mapping relationship between the physical L2 address of the destination end station that generated the response Ethernet frame and the source identifier of the other bridge.

18. The bridge device of claim 17 wherein the Ethernet MAC module further transmits the Ethernet frame into the first Ethernet edge network, if a destination identifier associated with the destination end station is not known by the bridge.

19. The bridge device of claim 17 wherein the mapping information resides in a FC name server accessible by the bridge.

20. The bridge device of claim 17 wherein the local mapping database is embodied in a local FC name server.
